(19) United States
(12) Patent Application Publication
(10) Pub. No.: US 2024/0429373 A1
(43) Pub. Date: Dec. 26, 2024

(54) CATHODE MATERIAL

(71) Applicant: NICHIA CORPORATION, Anan-shi (JP)

(72) Inventors: Shigenobu NODA, Tokushima-shi (JP); Takashi ENOMOTO, Tokushima-shi (JP); Hideyuki KIRIE, Anan-shi (JP); Kento ISAI, Anan-shi (JP); Kenichi KOBAYASHI, Tokushima-shi (JP)

(73) Assignee: NICHIA CORPORATION, Anan-shi (JP)

(21) Appl. No.: 18/708,203

(22) PCT Filed: Oct. 31, 2022
(86) PCT No.: PCT/JP2022/040767

§ 371 Date: May 7, 2024

(30) Foreign Application Priority Data
Nov. 8, 2021 (JP) 2021-181867

(51) Int. Cl. H01M 4/36; C01B 25/45; H01M 4/02; H01M 4/58; H01M 4/583

(52) U.S. Cl. CPC H01M 4/366; C01B 25/45; H01M 4/5825; H01M 4/5835; C01P 2002/60; C01P 2004/30; C01P 2004/50; C01P 2004/80; C01P 2006/10; C01P 2006/12; C01P 2006/40; H01M 2004/021; H01M 2004/028

(57) ABSTRACT

Provided is a cathode material that can further improve the high-rate performance in a lithium ion secondary battery. The cathode material inculeds secondary particles comprising: primary particles containing a lithium transition metal compound having an olivine structure; and carbon adhering to the surfaces of the primary particles, a plurality of which primary particles are aggregated. The content of the carbon is more than 0.5% by mass and 1.8% by mass or less with respect to the cathode material. The lithium transition metal compound has a crystallite size that is 50 nm to 70 nm. The cathode material has a specific surface area that is 14 m²/g to 45 m²/g.

### TECHNICAL FIELD

The present disclosure relates to a cathode material.

### BACKGROUND ART

As cathode materials that can be utilized in lithium ion secondary batteries, lithium transition metal compounds having an olivine structure are known. For example, Japanese Laid-Open Patent Publication No. 2019-149355 proposes an electrode material that contains secondary particles, which are an aggregate of primary particles of an electrode active material, and a carbonaceous coating film covering the secondary particles.

### SUMMARY OF INVENTION

### Technical Problem

An object of one aspect of the present disclosure is to provide a cathode material that can further improve the high-rate performance in a lithium ion secondary battery.

### Solution to Problem

The first aspect is acathdode material including secondary particles that contain: primary particles containing a lithium transition metal compound having an olivine structure; and carbon adhering to a surface of the primary particles, a plurality of which primary particles are aggregated. In the positive electrode material, the content of carbon is more than 0.5% by mass and 1.8% by mass or less with respect to the cathode material. The lithium transition metal compound constituting the cathode material has a crystallite size that is 50 nm to 70 nm. Further, the positive electrode material has a specific surface area that is 14 m²/g to 45 m²/g.

### Advantageous Effects of Invention

According to one aspect of the present disclosure, a cathode material that may further improve the high-rate performance in a lithium ion secondary battery may be provided.

### DESCRIPTION OF EMBODIMENTS

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. Embodiments of the present invention will now be described in detail. The embodiments described below are exemplifications of a positive electrode material for embodying the technical ideas of the present invention, and the present invention is not limited to the positive electrode material described below.

### Cathode Material

The cathode material contains secondary particles formed by aggregation of plural primary particles that contain a lithium transition metal compound having an olivine structure and have carbon adhering to the surface. In the cathode material, the content of carbon is more than 0.5% by mass and 1.8% by mass or less with respect to the cathode material. The lithium transition metal compound constituting the cathode material has a crystallite size that is 50 nm to 70 nm. Further, the cathode material has a specific surface area that is 14 m²/g to 45 m²/g. The cathode material can be efficiently produced by, for example, the below-described method of producing a cathode material.

The cathode material is configured to contain secondary particles that are formed of plural primary particles containing a lithium transition metal compound having a prescribed crystallite size and to have a prescribed carbon content and a prescribed specific surface area, whereby the cathode material may improve the capacity density (e.g., 5C capacity density) under high-rate conditions in a lithium ion secondary battery constituted by using the cathode material. The reason for this is believed, for example, as follows. The larger the crystallite size (primary particle size), the greater the lithium ion migration distance within the lithium transition metal compound; therefore, it is believed that a smaller crystallite size leads to a further improvement in the lithium ion conductivity. In addition, a larger specific surface area is believed to lead to a larger area where lithium is de-inserted and thus a further improvement in the output, which is particularly important under high-rate conditions. Further, it is believed that an increase in the carbon content leads to an increase in the electron conductivity; however, an excessively high carbon content is believed to cause, for example, a reduction in the lithium ion conductivity and deterioration of the filling property. By controlling the crystallite size to be a specific size or smaller and preventing the specific surface area from exceeding a specific size, deterioration of the compactness of the secondary particles is prevented, so that not only the discharge capacity under high-rate conditions can be increased while ensuring the filling property, but also the high-rate performance may be improved.

A cathode that is formed using the cathode material has excellent packing property in a cathode active material layer that constitutes the cathode. The packing property of the cathode active material layer can be evaluated based on the density of pellets that are made of the cathode material and formed under prescribed conditions. When pellets are formed under a condition of 3.5 MPa, the density of pellets made of the cathode active material may be, for example, 1.8 g/cm³ to 2.3 g/cm³, preferably 1.9 g/cm³ or more, 1.93 g/cm³ or more, 1.96 g/cm³ or more, 2.0 g/cm³ or more, 2.04 g/cm³ or more, or 2.05 g/cm³ or more, and preferably 2.2 g/cm³ or less, 2.15 g/cm³ or less, 2.12 g/cm³ or less, 2.1 g/cm³ or less, 2.09 g/cm³ or less, or 2.08 g/cm³ or less.

The primary particles may contain a lithium transition metal compound having an olivine structure, and the primary particles may substantially consist of the lithium transition metal compound having an olivine structure. The term “substantially” used herein means that components other than the lithium transition metal compound having an olivine structure, which are unavoidably contained in the primary particles, are not excluded, and that the content of such components other than the lithium transition metal compound having an olivine structure in the primary particles is, for example, 1% by mass or less, preferably 0.5% by mass or less.

The lithium transition metal compound contained in the primary particles is a phosphate compound that contains, at least: a first metal containing at least one selected from the group consisting of cobalt (Co), manganese (Mn), nickel (Ni), iron (Fe), copper (Cu), and chromium (Cr); lithium (Li); phosphorus (P); and oxygen (O). In addition to the first metal, lithium, and phosphorus, the lithium transition metal compound may further contain, as required, a second metal containing at least one selected from the group consisting of Group 2 elements, Group 3 elements, Group 4 elements, Group 12 elements, Group 13 elements, and Group 14 elements.

The first metal preferably contains at least iron, and may further contain at least one selected from the group consisting of cobalt, manganese, nickel, copper, and chromium. As for the content of iron in the first metal, for example, a ratio of the number of moles of iron with respect to a total number of moles of the first metal may be 0.7 to 1, preferably 0.8 or higher, 0.9 or higher, or 0.95 or higher. When the content of iron in the first metal is in this range, a decrease in the charge-discharge capacity tends to be inhibited in a secondary battery using the cathode material.

The second metal may preferably contain at least one selected from the group consisting of magnesium (Mg), calcium (Ca), strontium (Sr), barium (Ba), scandium (Sc), yttrium (Y), titanium (Ti), zinc (Zn), boron (B), aluminum (Al), gallium (Ga), indium (In), silicon (Si), and germanium (Ge).

The lithium transition metal compound may have, for example, the following composition. A ratio of the number of moles of lithium with respect to the number of moles of phosphorus may be higher than 0.9 and lower than 1.1, preferably 0.95 or higher, 0.96 or higher, or 0.98 or higher, and 1.05 or lower, 1.02 or lower, or 1.00 or lower. A ratio of the number of moles of the first metal with respect to the number of moles of phosphorus may be 0.8 or higher and 1 or lower, preferably 0.9 or higher, 0.92 or higher, 0.95 or higher, 0.96 or higher, or 0.97 or higher, and 1 or lower, 0.99 or lower, 0.98 or lower, or 0.97 or lower. Further, a ratio of the number of moles of the second metal with respect to the number of moles of phosphorus may be 0 or higher and lower than 1, preferably 0 to 0.5. Moreover, a ratio of a total number of moles of the first metal and the second metal with respect to the number of moles of phosphorus may be higher than 0.9 and lower than 1.1, preferably 0.95 or higher, 0.96 or higher, or 0.97 or higher, and 1.05 or lower, 1 or lower, 0.99 or lower, 0.98 or lower, or 0.97 or lower.

The lithium transition metal compound may have a composition represented by, for example, the following Formula (1):

LiₓM¹_{y}M²_{z}PO_{4+α} (1)

In Formula (1), M¹ includes at least one selected from the group consisting of Co, Mn, Ni, Fe, Cu, and Cr; M² includes at least one selected from the group consisting of Mg, Ca, Sr, Ba, Sc, Y, Ti, Zn, B, Al, Ga, In, Si, and Ge; and x, y, z, and α may satisfy 0.9<x<1.1, 0.8<y≤1, 0≤z<1, 0.9<y+z<1.1, and −0.5≤α≤0.5, preferably 0.95≤x≤1.05, 0.9≤y≤1, 0≤z≤0.5, 0.95≤y+z≤1.05, and −0.3≤α≤0.5.

The secondary particles contained in the cathode material may have an average particle size (Dm) of, for example, 1 μm to 20 μm, preferably 2 μm or more, or 4 μm or more. The average particle size of the secondary particles may be preferably 18 μm or less, or 16 μm or less. The average particle size of the secondary particles may be a volume-average particle size, which is determined as the particle size corresponding to a cumulative volume of 50% from the small diameter side in a volume-based particle size distribution. The volume-based cumulative particle size distribution is measured using, for example, a laser-diffraction particle size distribution analyzer. When the average particle size of the secondary particles is in the above-described range, the workability during the production tends to be improved.

The lithium transition metal compound constituting the cathode material may have a crystallite sizethat is, for example, 50 nm to 70 nm, preferably 55 nm or more, 60 nm or more, 62 nm or more, or 64 nm or more, and preferably 68 nm or less, 67 nm or less, or 66 nm or less. When the crystallite size of the lithium transition metal compound is in this range, the lithium ion conductivity may be increased while inhibiting an increase in the carbon coverage, so that the high-rate performance tend to be further improved. The crystallite size of the lithium transition metal compound corresponds to the crystallite size in a crystalline phase of the lithium transition metal compound that is contained in the primary particles constituting the secondary particles. The crystallite size of the lithium transition metal compound is measured, for example, in the following method. For the cathode material as a sample, the X-ray diffraction (XRD) pattern is measured using an X-ray diffractometer. The crystallite size of the sample may be determined by fitting the XRD pattern of a crystal structure model of the lithium transition metal compound that may be obtained from the International Centre for Diffraction Data (ICDD) or the like with the XRD pattern obtained by the measurement, using the least-squares method.

Carbon is adhered to the surface of the primary particles constituting the secondary particles. The adhesion of carbon may be, for example, physical adsorption by van der Waals force or the like. The adhered carbon may be in the form of particles or films, preferably in the form of films. The amount of carbon adhering to the primary particles may be evaluated as the carbon content in the cathode material. The carbon content in the cathode material may be, for example, more than 0.5% by mass and 1.8% by mass or less, preferably 1.6% by mass or less, 1.5% by mass or less, or 1.4% by mass or less, with respect to a total mass of the cathode material. The carbon content in the cathode material may be, for example, 0.8% by mass or more, preferably 0.9% by mass or more, 1.0% by mass or more, 1.1% by mass or more, or 1.2% by mass or more, with respect to a total mass of the cathode material. When the carbon content in the cathode material is in the above-described range, the high-rate performance tend to be improved while a high pellet density is maintained. The carbon content in the cathode material can be measured using, for example, a total organic carbon meter (TOC meter).

The cathode material may have a specific surface area of, for example, 14 m²/g to 45 m²/g, preferably 15 m²/g or more, 17 m²/g or more, 20 m²/g or more, or 22 m²/g or more. The specific surface area of the cathode material may be preferably 35 m²/g or less, 30 m²/g or less, 28 m²/g or less, 26 m²/g or less, or 24 m²/g or less. When the specific surface area of the cathode material is in the above-described range, the reaction area where lithium is de-inserted is increased while an increase in the carbon coverage is inhibited, so that the high-rate performance tend to be further improved. The specific surface area of the cathode material may be the specific surface area determined in accordance with the BET method, and is measured by a single-point method using nitrogen gas based on the BET (Brunauer Emmett Teller) theory.

The cathode material may have an oil absorption amount of, for example, less than 50 ml/100 g, preferably 40 ml/100 g or less, 35 ml/100 g or less, or 34 ml/100 g or less, with respect to N-methyl-2-pyrrolidone (NMP). The oil absorption amount may be, for example, 10 ml/100 g or more, preferably 15 ml/100 g or more, 20 ml/100 g or more, 25 ml/100 g or more, 28 ml/100 g or more, or 30 ml/100 g or more. When the oil absorption amount is in the above-described range, the secondary particles may be densified, so that the pellet density tends to be improved. The oil absorption amount of the cathode material is measured in accordance with the method prescribed in JIS K5101-13-1.

Within a pore diameter range of 0.01 μm to 10 μm in a logarithmic differential pore volume distribution obtained using a mercury porosimeter, the cathode material may have a mode pore size in a pore diameter range of 0.01 μm to 0.2 μm. The mode pore size within the pore diameter range of 0.01 μm to 10 μm may preferably exist in a range of 0.015 μm or more, or 0.02 μm or more, but preferably 0.1 μm or less, or 0.08 μm or less. When the mode pore size exists in the above-described range, the pellet density may be increased while maintaining a conductive path of lithium ions, so that the high-rate performance may be further improved.

In the cathode material, the larger a product of the specific surface area and the crystallite size of the lithium transition metal compound and the smaller a product of the oil absorption amount and the carbon content, the further high-rate performance in a secondary battery tend to be improved. Therefore, for example, a correlation value that is obtained by dividing a product of the specific surface area (m²/g) of the cathode material and the crystallite size (nm) of the lithium transition metal compound by a product of the oil absorption amount (ml/100 g) and the carbon content (% by mass) of the cathode material (this value is hereinafter also simply referred to as “correlation value”) may have a positive correlation with the capacity density (mAh/cm³) under high-load conditions. The correlation value may be, for example, 20 or larger, preferably 28 or larger, 30 or larger, or 32 or larger, and may be, for example, 50 or smaller, 45 or smaller, or 40 or smaller.

### Positive Electrode for Lithium Ion Secondary Battery

A positive electrode for a lithium ion secondary battery includes a current collector, and a cathode active material layer that is arranged on the current collector and contains the above-described cathode material. A lithium ion secondary battery provided with this positive electrode may achieve excellent charge-discharge capacity.

The positive electrode active material layer may have a density of, for example, 1.6 g/cm³ to 2.8 g/cm³, preferably 1.8 g/cm³ to 2.6 g/cm³, 1.9 g/cm³ to 2.5 g/cm³, or 2.0 g/cm³ to 2.4 g/cm³. The density of the positive electrode active material layer is calculated by dividing the mass of the positive electrode active material layer by the volume of the positive electrode active material layer. It is noted here that the density of the positive electrode active material layer may be adjusted by applying the below-described electrode composition onto the current collector and subsequently applying thereto a pressure.

The material of the current collector may be, for example, aluminum, nickel, or stainless steel. The positive electrode active material layer may be formed by applying an electrode composition, which is obtained by mixing the above-described cathode material, a conductive agent, a binder, and the like together with a solvent, onto the current collector, and subsequently performing a drying treatment, a pressure treatment, and the like of the resultant. Examples of the conductive agent include natural graphite, artificial graphite, and acetylene black. Examples of the binder include polyvinylidene fluoride, polytetrafluoroethylene, and polyamide acrylic resin. Examples of the solvent include N-methyl-2-pyrrolidone (NMP).

### Lithium Ion Secondary Battery

A lithium ion secondary battery includes the above-described positive electrode for a lithium ion secondary battery. The lithium ion secondary battery is configured to include a negative electrode for a lithium ion secondary battery, a nonaqueous electrolyte, a separator, and the like, in addition to the positive electrode for a lithium ion secondary battery. As the negative electrode for a lithium ion secondary battery, the nonaqueous electrolyte, the separator, and the like in the lithium ion secondary battery, those used in lithium ion secondary batteries that are described in, for example, Japanese Laid-Open Patent Publication Nos. 2002-075367, 2011-146390, and 2006-12433 (the disclosures of which are hereby incorporated by reference in their entirety) can be used as appropriate.

### Method of Producing Cathode Material

A method of producing the cathode material may include: the providing step of providing a raw material mixture that contains a first metal source containing at least one selected from the group consisting of cobalt, manganese, nickel, iron, copper, and chromium, a lithium source, a carbon source, and a liquid medium, in which at least one of the first metal source and the lithium source contains a phosphate; the granulation step of granulating the raw material mixture to obtain a precursor having a volume-average particle size of 5 μm to 30 μm; and the heat treatment step of heat-treating the precursor at a temperature in a range of 500° C. to 700° C. to obtain a heat-treated product. The heat-treated product obtained in the heat treatment step may contain the cathode material.

In the providing step, a raw material mixture containing a first metal source, a lithium source, a carbon source, and a liquid medium is prepared. The first metal source may contain a metal compound that contains a first metal atom containing at least one selected from the group consisting of cobalt, manganese, nickel, iron, copper, and chromium, or the first metal atom itself. Examples of the metal compound include phosphates, nitrates, carbonates, and oxides, and the metal compound may contain at least a phosphate. The first metal source contains at least an iron compound, preferably iron phosphate (e.g., Fe₃(PO₄)₂), and may further contain a metal compound that contains at least one selected from the group consisting of cobalt, manganese, nickel, copper, and chromium. When the iron contained in the first metal source is divalent iron, carbonization of the carbon source is likely to occur before the crystal growth of the lithium transition metal compound, as a result of which the specific surface area of the resulting cathode material is further increased, so that the discharge capacity under high-rate conditions tends to be further increased. The ratio of the number of moles of iron contained in the first metal source may be, for example, 0.7 to 1, preferably 0.8 or higher, 0.9 or higher, or 0.95 or higher, with respect to a total number of moles of the first metal atom contained in the first metal source.

As for the content of the first metal source in the raw material mixture, for example, a ratio of the number of moles of the first metal atom with respect to a total number of moles of phosphorus contained in the raw material mixture may be higher than 0.8 and 1.8 or lower, preferably 0.9 to 1.6.

The lithium source may contain a lithium compound and the like. Examples of the lithium compound include lithium phosphate, lithium carbonate, and lithium hydroxide. The lithium source may preferably contain at least lithium phosphate (e.g., Li₃PO₄). As for the content of the lithium source in the raw material mixture, for example, a ratio of the number of moles of lithium contained in the lithium source with respect to a total number of moles of phosphorus contained in the raw material mixture may be higher than 0.9 and lower than 1.1, preferably 0.95 to 1.05. Further, as for the content of the lithium source in the raw material mixture, a ratio of the number of moles of lithium contained in the lithium source with respect to a total number of moles of the first metal atom contained in the first metal source may be, for example, 1 to 1.1, preferably 1.01 or higher, or 1.02 or higher, and preferably 1.07 or lower, or 1.05 or lower.

The carbon source may be carbon itself, or a carbon compound that can generate carbon when heat-treated. Examples of the carbon compound that may be contained in the carbon source include dextrin, sucrose, and starch, and the carbon source may contain at least one selected from the group consisting of these carbon compounds. From the viewpoint of carbonization ratio, the carbon source preferably contains dextrin.

The content of the carbon source in the raw material mixture may be, for example, 15% by mass to 30% by mass, preferably 16% by mass or more, 18% by mass or more, 19% by mass or more, or 20% by mass or more, and preferably 25% by mass or less, 24% by mass or less, or 23% by mass or less, with respect to a total mass of the first metal atom contained in the raw material mixture.

The liquid medium is not limited as long as it contains at least water, and the liquid medium may further contain a water-soluble organic solvent such as an alcohol or acetone, in addition to water. The raw material mixture may be configured as a slurry having a fluidity. The concentration of the first metal source in the raw material mixture may be, for example, 3% by mass to 15% by mass, preferably 4% by mass to 10% by mass, in terms of the concentration of the first metal atom.

As required, the raw material mixture may further contain a second metal source that contains a second metal atom containing at least one selected from the group consisting of Group 2 elements, Group 3 elements, Group 4 elements, Group 12 elements, Group 13 elements, and Group 14 elements. The second metal source may contain, for example, a metal compound containing the second metal atom, or the second metal atom itself. Examples of the metal compound include phosphates, oxides, carbonates, and halides, and the metal compound may contain at least a phosphate.

The second metal atom may preferably contain at least one selected from the group consisting of magnesium (Mg), calcium (Ca), strontium (Sr), barium (Ba), scandium (Sc), yttrium (Y), titanium (Ti), zinc (Zn), boron (B), aluminum (Al), gallium (Ga), indium (In), silicon (Si), and germanium (Ge).

As for the content of the second metal source in the raw material mixture, for example, a ratio of the number of moles of the second metal atom with respect to a total number of moles of phosphorus contained in the raw material mixture may be 0 or higher and lower than 1, preferably 0 to 0.5. Further, a ratio of a total number of moles of the first metal atom and the second metal atom with respect to a total number of moles of phosphorus contained in the raw material mixture may be higher than 0.9 and lower than 1.1, preferably 0.95 to 1.05.

As required, the raw material mixture may further contain a phosphate compound. Examples of the phosphate compound include ammonium phosphate and phosphoric acid. For example, ammonium dihydrogen phosphate may be used as ammonium phosphate. As for the content of the phosphate compound in the raw material mixture, for example, a ratio of the number of moles of the phosphate compound with respect to a total number of moles of the first metal atom contained in the raw material mixture may be 0% by mole to 3% by mole (0 to 0.03), preferably 0.5% by mole to 2.5% by mole. This ratio may be preferably 1.0% by mole or more, or 1.5% by mole or more, and 2% by mole or less, or 1.8% by mole or less. When the content of the phosphate compound in the raw material mixture is in the above-described range, a cathode material with further improved crystallinity tends to be easily obtained.

As required, the raw material mixture may also contain a pH modifier. Examples of the pH modifier include citric acid, sulfuric acid, and ammonium carbonate. The content of the pH modifier in the raw material mixture may be adjusted as appropriate such that the raw material mixture exhibits the desired pH.

The raw material mixture may be prepared by performing a pulverization treatment of a composition that contains the first metal source, the lithium source, the carbon source, the liquid medium and, as required, the second metal source, the phosphate compound, the pH modifier, and the like. The pulverization treatment may be performed using, for example, a ball mill, a vibration mill, a roll mill, or a crusher. The raw material mixture obtained by the pulverization treatment may be prepared as a slurry having a fluidity.

The pulverization treatment may be performed such that the raw material mixture has a volume-average particle size of 0.05 μm to 1 μm, preferably 0.1 μm to 0.5 μm. The solid concentration of the raw material mixture may be, for example, 5% by mass to 50% by mass, preferably 10% by mass to 30% by mass. The volume-average particle size of the raw material mixture is measured using a laser-diffraction particle size distribution analyzer.

In the granulation step, at least a portion of the liquid medium contained in the raw material mixture to be prepared is removed to obtain a precursor as a dry product. The thus obtained precursor may have a volume-average particle size of, for example, 5 μm to 30 μm, preferably 7 μm to 25 μm. Examples of a method of drying the raw material mixture include spray drying and fluidized bed drying, and spray drying is preferred. The volume-average particle size of the precursor is measured using a laser-diffraction particle size distribution analyzer.

In the heat treatment step, the precursor is heat-treated to obtain a heat-treated product. The temperature of the heat treatment may be in a range of, for example, 500° C. to 700° C., preferably 600° C. to 650° C. The heat treatment step may include: raising the temperature to a prescribed heat treatment temperature; maintaining this heat treatment temperature; and lowering the temperature from the heat treatment temperature. As for the rate of temperature increase to the heat treatment temperature, for example, the rate of temperature increase from room temperature may be 2.5° C./min to 5° C./min, preferably 3.0° C./min or faster, or 3.3° C./min or faster, and preferably 4.5° C./min or slower, or 4.2° C./min or slower. The heat treatment time in which the heat treatment temperature is maintained may be, for example, 0.1 hours to 15 hours, preferably 0.2 hours or longer, 0.3 hours or longer, or 0.4 hours or longer, and preferably 12 hours or shorter, 8 hours or shorter, or 5 hours or shorter. As for the rate of temperature decrease from the heat treatment temperature, for example, the rate of temperature decrease to room temperature may be 1° C./min to 600° C./min.

The atmosphere in the heat treatment step may be, for example, an inert gas atmosphere containing a noble gas such as argon or nitrogen. The inert gas atmosphere may have an inert gas content of, for example, 90% by volume or more, preferably 95% by volume or more, or 98% by volume or more. The heat treatment may be performed in an inert gas stream.

The pressure of the atmosphere in the heat treatment step may be the atmospheric pressure, or the heat treatment step may be performed in a pressurized or depressurized condition. As the pressurization condition, the gauge pressure may be, for example, more than 0 MPa and 0.1 MPa or less, preferably more than 0 MPa and 0.05 MPa or less. As the depressurized condition, the gauge pressure may be, for example, −0.1 MPa or more and less than 0 MPa, preferably −0.05 MPa or more and less than 0 MPa.

The heat treatment of the precursor may be performed using, for example, a box-type atmosphere furnace, a tube furnace, or a carbon rotary kiln. The heat treatment of the precursor may be performed by, for example, filling the precursor into a crucible, a boat, or the like that is made of aluminum oxide. Other than aluminum oxide, for example, a carbon material such as graphite, a boron nitride (BN) material, or a molybdenum material may be used as well.

The heat-treated product obtained in the heat treatment step may be subjected to treatments such as pulverization, dispersion, washing, filtration, and classification, and the heat-treated product may be at least pulverized and classified.

### EXAMPLES

The present invention will now be described more concretely by way of Examples; however, the present invention is not limited to the below-described Examples.

In the following Examples and Comparative Examples, the ratio of the number of moles of lithium and the ratio of the number of moles of iron with respect to the number of moles of phosphorus were measured using an inductively-coupled plasma atomic emission spectrometer (ICP-AES; manufactured by PerkinElmer Co., Ltd.). The carbon content was measured using a total organic carbon meter (TOC meter; ON-LINE TOC-V_{CSH}, manufactured by Shimadzu Corporation). The volume-average particle size was measured using a laser-diffraction particle size distribution analyzer (SALD-3100, manufactured by Shimadzu Corporation). The specific surface area according to the BET method was measured by a single-point method using nitrogen gas. The crystallite size was measured by an X-ray diffraction method. Specifically, an X-ray diffraction spectrum (tube current=45 mA, tube voltage=200 kV) was measured using CuKα rays, and the diffraction peak obtained around 2θ=32° (attributed to the (031) plane in the space group Pmnb) was fitted by the least-squares method using the Pseudo-Voigt function, followed by calculation of the θ and β values. The crystallinity is calculated by the following Formula (2) from the diffraction peaks attributed to the (031) plane that were determined by the X-ray diffraction method.

D=K′λ/(βcos θ) (2)

In the above formula, D represents a crystallinity (Å), λ represents the wavelength of an X-ray source (1.54 Å in the case of CuKα), β represents an integral width (radian), and θ represents a diffraction angle (degree). As K′, a value which is measured using sintered Si for optical system adjustment (manufactured by Rigaku Corporation) and at which the crystallinity D attributed to the (022) plane is 1,000 Å as calculated by the above Formula (2) is used. A value obtained by multiplying the thus calculated crystallinity D (Å) by 10 is the crystallite size (nm). The oil absorption amount with respect to NMP was measured as the amount of NMP that was made into a slurry when NMP was added dropwise with mixing. Further, the mode pore size was measured using a POREMASTER-60 manufactured by Anton Paar GmbH (formerly Quantachrome Instruments).

### Example 1

A slurry in an amount of 1,496.3 g, which was prepared by dispersing iron phosphate (Fe₃(PO₄)₂) in pure water such that the iron atom concentration was 8.02% by mass, 86.3 g of lithium phosphate (Li₃PO₄), 4.2 g of ammonium dihydrogen phosphate, 3.0 g of citric acid, and 1,233 g of pure water were put into a ball mill container and mixed while being micronized by a 40-hour pulverization treatment using a zirconia ball. Subsequently, 177.6 g of a 15% by mass dextrin solution was added, and the resultant was further pulverized for 3 hours.

The ratio (Li/Fe) of the number of moles of lithium atoms contained in lithium phosphate with respect to the number of moles of iron atoms contained in the raw material mixture was 1.04, and the ratio (PO₄/Fe) of the number of moles of ammonium dihydrogen phosphate with respect to the number of moles of iron atoms contained in the raw material mixture was 1.70% by mole. Further, the ratio (C/Fe) of the mass of dextrin and the ratio of the mass of citric acid were 22% by mass and 2.5% by mass, respectively, with respect to the mass of iron atoms contained in the raw material mixture.

The raw material mixture after the pulverization treatment was spray-dried to obtain a precursor having an average particle size of 7 μm to 8 μm. The particle size of the primary particles constituting the precursor was found to be several ten nanometers by observation under a scanning electron microscope (SEM). The thus obtained precursor in an amount of 50 g was filled into an alumina crucible of 90 mm in length and width and 50 mm in height, and heat-treated at 650° C. for 11 hours in a nitrogen gas atmosphere to obtain a heat-treated product of Example 1. In this heat treatment, nitrogen gas was allowed to flow from the horizontal direction to the vicinity of the top of the crucible at a rate of 10 L/min.

Phase identification of the thus obtained heat-treated product was performed using an X-ray diffractometer. As a result of an analysis using CuKα rays (wavelength: λ=1.54 nm) as X-rays, an olivine-type lithium transition metal compound having a composition represented by LiFePO₄ was confirmed. In all of the below-described Examples and Comparative Examples, an olivine-type lithium transition metal compound having a composition represented by LiFePO₄ was confirmed as a heat-treated product in the same manner.

In the heat-treated product obtained in Example 1, the ratio (Li/P) of the number of moles of lithium with respect to the number of moles of phosphorus was 0.99, the ratio (Fe/P) of the number of moles of iron with respect to the number of moles of phosphorus was 0.97, the carbon content (C) was 1.2% by mass, the volume-average particle size (Dm) was 7.6 μm, the specific surface area (BET) determined by the BET method was 22 m²/g, the oil absorption amount with respect to NMP was 31 ml/100 g, and the crystallite size of the olivine-type lithium transition metal compound was 65.5 nm. Further, the correlation value obtained by dividing a product of the specific surface area of the cathode material and the crystallite size of the lithium transition metal compound by a product of the oil absorption amount of the cathode material and the carbon content of the cathode material was 39. Moreover, the mode pore size was 0.025 μm in a pore diameter range of 0.01 μm to 10 μm.

### Example 2

A heat-treated product of Example 2 was produced in the same manner as in Example 1, except that the amount of the dextrin solution was changed to 224.0 g.

In the heat-treated product obtained in Example 2, the ratio of the number of moles of lithium with respect to the number of moles of phosphorus was 0.99, the ratio of the number of moles of iron with respect to the number of moles of phosphorus was 0.97, the carbon content was 1.8% by mass, the volume-average particle size was 6.9 μm, the specific surface area determined by the BET method was 35 m²/g, the oil absorption amount with respect to NMP was 39 ml/100 g, and the crystallite size of the olivine-type lithium transition metal compound was 59.8 nm.

### Example 3

A heat-treated product of Example 3 was produced in the same manner as in Example 1, except that the amount of the dextrin solution was changed to 184.0 g.

In the heat-treated product obtained in Example 3, the ratio of the number of moles of lithium with respect to the number of moles of phosphorus was 0.99, the ratio of the number of moles of iron with respect to the number of moles of phosphorus was 0.97, the carbon content was 1.4% by mass, the volume-average particle size was 7.6 μm, the specific surface area determined by the BET method was 24 m²/g, the oil absorption amount with respect to NMP was 33 ml/100 g, and the crystallite size of the olivine-type lithium transition metal compound was 64.8 nm.

### Example 4

A heat-treated product of Example 4 was produced in the same manner as in Example 1, except that the amount of the dextrin solution was changed to 152.0 g.

In the heat-treated product obtained in Example 4, the ratio of the number of moles of lithium with respect to the number of moles of phosphorus was 1.00, the ratio of the number of moles of iron with respect to the number of moles of phosphorus was 0.98, the carbon content was 1.1% by mass, the volume-average particle size was 6.9 μm, the specific surface area determined by the BET method was 15 m²/g, the oil absorption amount with respect to NMP was 30 ml/100 g, and the crystallite size of the olivine-type lithium transition metal compound was 68.4 nm.

### Comparative Example 1

A heat-treated product of Comparative Example 1 was produced in the same manner as in Example 2, except that the amount of ammonium dihydrogen phosphate was changed to 3.6 g.

In the heat-treated product obtained in Comparative Example 1, the ratio of the number of moles of lithium with respect to the number of moles of phosphorus was 1.00, the ratio of the number of moles of iron with respect to the number of moles of phosphorus was 0.98, the carbon content was 1.9% by mass, the volume-average particle size was 6.7 μm, the specific surface area determined by the BET method was 31 m²/g, the oil absorption amount with respect to NMP was 39 ml/100 g, and the crystallite size of the olivine-type lithium transition metal compound was 49.0 nm.

### Comparative Example 2

A heat-treated product of Comparative Example 2 was produced in the same manner as in Example 1, except that ammonium dihydrogen phosphate was not added and the amount of the dextrin solution was changed to 136.0 g.

In the heat-treated product obtained in Comparative Example 2, the ratio of the number of moles of lithium with respect to the number of moles of phosphorus was 1.01, the ratio of the number of moles of iron with respect to the number of moles of phosphorus was 0.99, the carbon content was 0.5% by mass, the specific surface area determined by the BET method was 17 m²/g, the oil absorption amount with respect to NMP was 41 ml/100 g, and the crystallite size of the olivine-type lithium transition metal compound was 51.9 nm.

### Comparative Example 3

A heat-treated product of Comparative Example 3 was produced in the same manner as in Example 1, except that the amount of ammonium dihydrogen phosphate and that of the dextrin solution were changed to 4.7 g and 240.0 g, respectively, and the temperature of the heat treatment of the precursor was changed to 700° C.

In the heat-treated product obtained in Comparative Example 3, the ratio of the number of moles of lithium with respect to the number of moles of phosphorus was 1.00, the ratio of the number of moles of iron with respect to the number of moles of phosphorus was 0.98, the carbon content was 1.5% by mass, the specific surface area determined by the BET method was 23 m²/g, the oil absorption amount with respect to NMP was 39 ml/100 g, and the crystallite size of the olivine-type lithium transition metal compound was 79.0 nm.

### Comparative Example 4

A heat-treated product of Comparative Example 4 was produced in the same manner as in Example 1, except that the amount of ammonium dihydrogen phosphate and that of the dextrin solution were changed to 4.7 g and 240.0 g, respectively.

In the heat-treated product obtained in Comparative Example 4, the ratio of the number of moles of lithium with respect to the number of moles of phosphorus was 0.99, the ratio of the number of moles of iron with respect to the number of moles of phosphorus was 0.99, the carbon content was 1.9% by mass, the specific surface area determined by the BET method was 46 m²/g, the oil absorption amount with respect to NMP was 50 ml/100 g, and the crystallite size of the olivine-type lithium transition metal compound was 61.3 nm.

### Comparative Example 5

A heat-treated product of Comparative Example 5 was produced in the same manner as in Example 4, except that the space containing the alumina crucible was provided with a nitrogen gas atmosphere prior to the heat treatment of the precursor, and that nitrogen gas was not allowed to flow at a rate of 10 L/min during the heat treatment.

In the heat-treated product obtained in Comparative Example 5, the ratio of the number of moles of lithium with respect to the number of moles of phosphorus was 1.00, the ratio of the number of moles of iron with respect to the number of moles of phosphorus was 0.97, the carbon content was 1.3% by mass, the volume-average particle size was 7.3 μm, the specific surface area determined by the BET method was 13 m²/g, the oil absorption amount with respect to NMP was 43 ml/100 g, and the crystallite size of the olivine-type lithium transition metal compound was 69.3 nm.

### Evaluation

### Pellet Density

The pellet density was evaluated using each heat-treated product produced in Examples and Comparative Examples. The pellet density was determined by weighing 2.0000 g of each heat-treated product that was an olivine-type lithium transition metal compound, filling the heat-treated product into a 20-mm molded, pressing the heat-treated product at 3.5 MPa to measure the amount of reduction in height, and then calculating the weight per volume. The measurement results are shown in Table 1.

TABLE 1

| | | | | | Heat treated product | | | | | | | |
|---|---|---|---|---|---|---|---|---|---|---|---|---|
| | Production conditions | | | | | | | | | Oil | | |
| | | | Heat treating | | | | | | | absorption | | Pellet |
| | PO₄/Fe | C/Fe | Temperature | N₂ | | | C | BET | Crystallite | amount | Correlation | density |
| | (mol %) | (mass %) | (° C.) | Flow | Li/P | Fe/P | (mass %) | (m²/g) | size (nm) | (ml/100 g) | value | (g/cm³) |
| Example 1 | 1.70 | 22 | 650 | ON | 0.99 | 0.97 | 1.2 | 22 | 65.5 | 31 | 39 | 2.06 |
| Example 2 | 1.70 | 28 | 650 | ON | 0.99 | 0.97 | 1.8 | 35 | 59.8 | 39 | 30 | 1.95 |
| Example 3 | 1.70 | 23 | 650 | ON | 0.99 | 0.97 | 1.4 | 24 | 64.8 | 33 | 34 | 2.05 |
| Example 4 | 1.70 | 19 | 650 | ON | 1.00 | 0.98 | 1.1 | 15 | 68.4 | 30 | 31 | 2.09 |
| Comparative | 1.46 | 28 | 650 | ON | 1.00 | 0.98 | 1.9 | 31 | 49.0 | 39 | 21 | 1.84 |
| Example 1 | | | | | | | | | | | | |
| Comparative | — | 17 | 650 | ON | 1.01 | 0.99 | 0.5 | 17 | 51.9 | 41 | 42 | 1.83 |
| Example 2 | | | | | | | | | | | | |
| Comparative | 1.90 | 30 | 700 | ON | 1.00 | 0.98 | 1.5 | 23 | 79.0 | 39 | 31 | 1.86 |
| Example 3 | | | | | | | | | | | | |
| Comparative | 1.90 | 30 | 650 | ON | 0.99 | 0.99 | 1.9 | 46 | 61.3 | 50 | 30 | 1.90 |
| Example 4 | | | | | | | | | | | | |
| Comparative | 1.70 | 19 | 650 | OFF | 1.00 | 0.97 | 1.3 | 13 | 69.3 | 43 | 16 | 1.92 |
| Example 5 | | | | | | | | | | | | |

For the cathode materials of Examples and Comparative Examples, the discharge capacity was evaluated in the following manner.

### Assembly of Evaluation Batteries

### Production of Positive Electrode

A positive electrode mixture slurry was prepared by dispersing 87.5 parts by mass of each cathode material, 2.5 parts by mass of acetylene black, and 10 parts by mass of polyvinylidene fluoride (PVDF) in N-methyl-2-pyrrolidone (NMP). The thus obtained positive electrode mixture slurry was applied to an aluminum foil serving as a current collector, and the resultant was dried, subsequently compression-molded using a roll press, and then cut to a prescribed size, whereby a positive electrode was produced.

### Production of Negative Electrode

A negative electrode slurry was prepared by dispersing and dissolving 97.5 parts by mass of artificial graphite, 1.5 parts by mass of carboxymethylcellulose (CMC), and 1.0 part by mass of a styrene-butadiene rubber (SBR) in pure water. The thus obtained negative electrode slurry was applied to a current collector made of a copper foil, and the resultant was dried, subsequently compression-molded using a roll press, and then cut to a prescribed size, whereby a negative electrode was produced.

After attaching a lead electrode to each of the positive electrode current collector and the negative electrode current collector, a separator was arranged between the positive electrode and the negative electrode, and these members were stored in a bag-shaped laminate pack. Subsequently, this pack was vacuum-dried at 65° C. to remove moisture adsorbed on each member. Thereafter, an electrolyte solution was injected into the laminate pack under an argon atmosphere, and the laminate pack was sealed to produce an evaluation battery. As the electrolyte solution, a solution obtained by mixing ethylene carbonate (EC) and ethyl methyl carbonate (EMC) at a volume ratio of 3:7 and dissolving the resulting mixture in lithium hexafluorophosphate (LiPF₆) at a concentration of 1 mol/L was used. The evaluation battery obtained in this manner was placed in a 25° C. incubator, aged with a weak current, and then evaluated as follows.

### Discharge Capacity

The above-produced evaluation battery was subjected to constant-voltage constant-current charging (cutoff current=0.005 C) at a charging voltage of 3.65 V and a charging current of 0.1 C, and then constant-current discharged at a discharge termination voltage of 2.0 V and a discharge current of 5 C to measure the discharge capacity (mAh/g). The 5C capacity density was calculated using the above-obtained pellet density value.

TABLE 2

| | | | | | 5 C |
|---|---|---|---|---|---|
| | 0.2 C | | | 5 C | capacity |
| | Charge | Discharge | | Discharge | density |
| | capacity | capacity | Efficiency | capacity | (mAh/ |
| | (mAh/g) | (mAh/g) | (%) | (mAh/g) | cm³) |
| Example 1 | 162 | 162 | 100 | 144 | 297.8 |
| Example 2 | 160 | 162 | 101 | 146 | 286.1 |
| Example 3 | 163 | 162 | 100 | 144 | 295.0 |
| Example 4 | 163 | 161 | 98 | 139 | 289.5 |
| Comparative | 158 | 163 | 103 | 150 | 276.6 |
| Example 1 | | | | | |
| Comparative | 128 | 101 | 79 | 35 | 64.9 |
| Example 2 | | | | | |
| Comparative | 161 | 150 | 93 | 119 | 221.3 |
| Example 3 | | | | | |
| Comparative | 159 | 159 | 100 | 143 | 271.7 |
| Example 4 | | | | | |
| Comparative | 161 | 158 | 98 | 133 | 255.7 |
| Example 5 | | | | | |

It is seen that the evaluation batteries using the respective cathode materials of Examples had a high 5C capacity density with further improved high-rate performance.

The disclosure of Japanese Patent Application No. 2021-181867 (filing date: Nov. 8, 2021) is incorporated herein by reference in its entirety. All documents, patent applications, and technical standards cited in the present description are incorporated herein by reference to the same extent as in cases where the individual documents, patent applications, and technical standards are specifically and individually described to be incorporated by reference.

What is claimed is:

1.-4. (canceled)

5. A cathode material, comprising secondary particles that comprise: primary particles comprising a lithium transition metal compound having an olivine structure; and carbon adhering to the surfaces of the primary particles, a plurality of which primary particles are aggregated,
wherein
the content of the carbon is more than 0.5% by mass and 1.8% by mass or less with respect to the cathode material,
the lithium transition metal compound has a crystallite size of 50 nm to 70 nm, and
the cathode material has a specific surface area of 14 m²/g to 45 m²/g.

6. The cathode material according to claim 5, having an oil absorption amount of less than 50 ml/100 g with respect to N-methyl-2-pyrrolidone.

7. The cathode material according to claim 5,
wherein
the lithium transition metal compound is a phosphate compound that comprises: a first metal comprising at least one selected from the group consisting of cobalt, manganese, nickel, iron, copper, and chromium; lithium; and phosphorus; and optionally further comprises a second metal comprising at least one selected from the group consisting of Group 2 to Group 4 elements and Group 12 to Group 14 elements, and
the lithium transition metal compound has a composition in which: a ratio of a number of moles of lithium with respect to a number of moles of phosphorus is higher than 0.9 and lower than 1.1; a ratio of a number of moles of the first metal with respect to the number of moles of phosphorus is higher than 0.8 and 1 or lower; a ratio of a number of moles of the second metal with respect to the number of moles of phosphorus is 0 or higher and lower than 1; and a ratio of a total number of moles of the first metal and the second metal with respect to the number of moles of phosphorus is higher than 0.9 and lower than 1.1.

8. The cathode material according to claim 6,
wherein
the lithium transition metal compound is a phosphate compound that comprises: a first metal comprising at least one selected from the group consisting of cobalt, manganese, nickel, iron, copper, and chromium; lithium; and phosphorus, and optionally further comprises a second metal comprising at least one selected from the group consisting of Group 2 to Group 4 elements and Group 12 to Group 14 elements, and
the lithium transition metal compound has a composition in which: a ratio of a number of moles of lithium with respect to a number of moles of phosphorus is higher than 0.9 and lower than 1.1; a ratio of a number of moles of the first metal with respect to the number of moles of phosphorus is higher than 0.8 and 1 or lower; a ratio of a number of moles of the second metal with respect to the number of moles of phosphorus is 0 or higher and lower than 1; and a ratio of a total number of moles of the first metal and the second metal with respect to the number of moles of phosphorus is higher than 0.9 and lower than 1.1.

9. The cathode material according to claim 5, wherein the lithium transition metal compound has a composition represented by the following formula:
LiₓM¹_{y}M²_{z}PO_{4+α}
wherein, M¹ comprises at least one selected from the group consisting of Co, Mn, Ni, Fe, Cu, and Cr; M² comprises at least one selected from the group consisting of Mg, Ca, Sr, Ba, Sc, Y, Ti, Zn, B, Al, Ga, In, Si, and Ge; and x, y, z, and α satisfy 0.9<x<1.1, 0.8<y≤1, 0≤z<1, 0.9<y+z<1.1, and −0.5≤α≤0.5.

10. The cathode material according to claim 6, wherein the lithium transition metal compound has a composition represented by the following formula:
LiₓM¹_{y}M²_{z}PO_{4+α}
wherein, M¹ comprises at least one selected from the group consisting of Co, Mn, Ni, Fe, Cu, and Cr; M² comprises at least one selected from the group consisting of Mg, Ca, Sr, Ba, Sc, Y, Ti, Zn, B, Al, Ga, In, Si, and Ge; and x, y, z, and α satisfy 0.9<x<1.1, 0.8<y≤1, 0≤z<1, 0.9<y+z<1.1, and −0.5≤α≤0.5.

11. The positive electrode material according to claim 7, wherein the lithium transition metal compound has a composition represented by the following formula:
LiₓM¹_{y}M²_{z}PO_{4+α}
wherein, M¹ comprises at least one selected from the group consisting of Co, Mn, Ni, Fe, Cu, and Cr; M² comprises at least one selected from the group consisting of Mg, Ca, Sr, Ba, Sc, Y, Ti, Zn, B, Al, Ga, In, Si, and Ge; and x, y, z, and α satisfy 0.9<x<1.1, 0.8<y≤1, 0≤z<1, 0.9<y+z<1.1, and −0.5≤α≤0.5.

12. The positive electrode material according to claim 8, wherein the lithium transition metal compound has a composition represented by the following formula:
LiₓM¹_{y}M²_{z}PO_{4+α}
wherein, M¹ comprises at least one selected from the group consisting of Co, Mn, Ni, Fe, Cu, and Cr; M² comprises at least one selected from the group consisting of Mg, Ca, Sr, Ba, Sc, Y, Ti, Zn, B, Al, Ga, In, Si, and Ge; and x, y, z, and α satisfy 0.9<x<1.1, 0.8<y≤1, 0≤z<1, 0.9<y+z<1.1, and −0.5≤α≤0.5.
